(19) United States
(12) Patent Application Publication
(10) Pub. No.: US 2015/0263384 A1
(43) Pub. Date: Sep. 17, 2015

(54) PRODUCTION OF HIGH-PURITY LITHIUM DIFLUOROPHOSPHATE

(71) Applicant: LANXESS Deutschland GmbH, Köln (DE)

(72) Inventors: Matthias Boll, Cologne (DE); Wolfgang Ebenbeck, Leverkusen (DE)

(21) Appl. No.: 14/430,642

(22) PCT Filed: Sep. 27, 2013
(86) PCT No.: PCT/EP2013/070284

§ 371 Date: Mar. 24, 2015

(30) Foreign Application Priority Data
Sep. 28, 2012 (EP) 12186484.7

(51) Int. Cl. H01M 10/0568; C01D 15/00

(52) U.S. Cl. CPC H01M 10/0568; C01D 15/00; H01M 2300/0025

(57) ABSTRACT

The present invention relates to a process for preparing high-purity, especially low-sodium, lithium difluorophosphate, especially in the form of solutions thereof in organic solvents, proceeding from lithium fluoride and phosphorus pentafluoride.

The present invention relates to a process for preparing high-purity, especially low-sodium, lithium difluorophosphate, especially in the form of solutions thereof in organic solvents, proceeding from lithium fluoride and phosphorus pentafluoride.

The global spread of portable electronic devices, for example laptop and palmtop computers, mobile phones or video cameras, and hence also the demand for lightweight and high-performance batteries and accumulators, has increased dramatically in the last few years. This will be augmented in the future by the equipping of electrical vehicles with accumulators and batteries of this kind.

Lithium difluorophosphate (LiPO₂F₂) has attracted industrial interest as a conductive salt in the production of high-performance accumulators as an alternative to lithium hexafluorophosphate, because it is quite stable. In order to assure the ability of such accumulators to function and the lifetime and hence the quality thereof, it is particularly important that the lithium compounds used are of high purity and, more particularly, contain minimum proportions of other metal ions such as, more particularly, sodium or potassium ions. Extraneous metal ions are held responsible for cell short-circuits owing to precipitate formation (U.S. Pat. No. 7,981,388). High chloride contents are held responsible for corrosion.

The prior art discloses only a few processes for preparing lithium difluorophosphate.

WO 2012/004188 A discloses a process in which tetraphosphorus decaoxide (P₄O₁₀) is reacted with lithium fluoride (LiF) at temperatures of above 300° C. to give lithium difluorophosphate.

WO 2008/111367 A discloses a process in which chlorides and bromides are reacted with lithium hexafluorophosphate and water.

EP 2 061 115 discloses a process in which lithium hexafluorophosphate is partly hydrolysed with water in the presence of siloxanes to obtain lithium difluorophosphate and lithium tetrafluorophosphate.

A common factor to all the processes is that they either proceed in an unspecific manner with regard to the target products thereof or produce high amounts of unavoidable by-products.

The prior art shows that it is technically very complex to achieve high purities for lithium difluorophosphate, and especially to keep the content of extraneous metal ions and the chloride content low. The processes known to date for preparing lithium difluorophosphate are consequently unable to fulfil every purity demand.

Accordingly, the problem addressed by the present invention was that of providing an efficient process for preparing high-purity lithium difluorophosphate or high-purity solutions comprising lithium difluorophosphate in organic solvents, which does not need complex purifying operations and gives high yields.

The solution to the problem and the subject-matter of the present invention is a process for preparing lithium difluorophosphate comprising at least the step of:
a) contacting solid lithium fluoride with a gas comprising phosphorus pentafluoride, the solid lithium fluoride having a water content of more than 1500 ppm, preferably 1550 ppm or more, especially preferably 1550 ppm to 100 000 ppm, even more preferably 2000 ppm to 20 000 ppm and very especially preferably 5000 ppm to 15 000 ppm.

If solutions of lithium difluorophosphate in organic solvent are to be prepared, this is preferably followed by at least the following steps:
b) contacting the reaction mixture comprising lithium difluorophosphate formed in a) with an organic solvent, causing the lithium difluorophosphate formed to go at least partly into solution,
c) optionally but preferably separating solid constituents from the solution comprising lithium hexafluorophosphate.

It should be noted at this point that the scope of the invention includes any and all possible combinations of the components, ranges of values and/or process parameters mentioned above and cited hereinafter, in general terms or within areas of preference.

In step a), solid lithium fluoride comprising the above-specified water content is contacted with a gas comprising phosphorus pentafluoride to obtain a reaction mixture comprising lithium difluorophosphate and unconverted lithium fluoride.

The lithium fluoride used in step a) has, for example, a purity level of 98.0000 to 99.9999% by weight, preferably 99.0000 to 99.9999% by weight, more preferably 99.9000 to 99.9995% by weight, especially preferably 99.9500 to 99.9995% by weight and very especially preferably 99.9700 to 99.9995% by weight, based on anhydrous product.

The lithium fluoride used additionally preferably has extraneous ions in:
1) a content of 0.1 to 250 ppm, preferably 0.1 to 75 ppm, more preferably 0.1 to 50 ppm and especially preferably 0.5 to 10 ppm and very especially preferably 0.5 to 5 ppm of sodium in ionic form and
2) a content of 0.01 to 200 ppm, preferably 0.01 to 10 ppm, more preferably 0.5 to 5 ppm and especially preferably 0.1 to 1 ppm of potassium in ionic form.

The lithium fluoride used additionally preferably has extraneous ions in
3) a content of 0.05 to 500 ppm, preferably 0.05 to 300 ppm, more preferably 0.1 to 250 ppm and especially preferably 0.5 to 100 ppm of calcium in ionic form and/or
4) a content of 0.05 to 300 ppm, preferably 0.1 to 250 ppm and especially preferably 0.5 to 50 ppm of magnesium in ionic form.

The lithium fluoride used additionally has, for example, extraneous ions in
i) a content of 0.1 to 1000 ppm, preferably 0.1 to 100 ppm and especially preferably 0.5 to 10 ppm of sulphate and/or
ii) a content of 0.1 to 1000 ppm, preferably 0.5 to 500 ppm, of chloride, likewise based on the anhydrous product, where the sum total of lithium fluoride and the aforementioned extraneous ions does not exceed 1 000 000 ppm, based on the total weight of the technical grade lithium carbonate based on the anhydrous product.

In one embodiment, the lithium fluoride contains a content of extraneous metal ions totaling 1000 ppm or less, preferably 300 ppm or less, especially preferably 20 ppm or less and very especially preferably 10 ppm or less.

The contacting of solid lithium fluoride comprising the above-specified water content with a gas comprising phosphorus pentafluoride to obtain a reaction mixture comprising lithium difluorophosphate and unconverted lithium fluoride can be effected by any method known to those skilled in the art for the reaction of gaseous substances with solid substances. For example, the contacting can be effected in a fixed bed or a fluidized bed, preference being given to contacting in a fluidized bed. In one embodiment, the fluidized bed may be configured as a stirred fluidized bed.

The solid lithium fluoride used may be used, especially when used in the form of a fixed bed, for example, in the form of shaped bodies or in the form of fine particles, i.e., for example, in the form of a powder, preference being given to the use of fine particles or powders, especially for use in the form of a fluidized bed.

When shaped bodies are used, preference is given to those having a solids content in the range from 20 to 95% by weight, preferably in the range from 60 to 90% by weight, especially preferably at 67 to 73% by weight and very especially preferably about 70% by weight.

Shaped bodies may in principle be in any desired form, preference being given to spherical, cylindrical or annular shaped bodies. The shaped bodies are preferably not larger than 3 cm, preferably not larger than 1.5 cm, in any dimension.

Shaped bodies are produced, for example, by extrusion from a mixture of lithium fluoride and water, the shaped bodies being dried after extrusion at temperatures of 50 to 200° C., preferably at temperatures of 80 to 150° C., especially preferably at about 120° C., until they have the above-specified water content. Shaped bodies of this kind are typically cylindrical.

Water contents are determined, unless stated otherwise, by the Karl Fischer method, which is known to those skilled in the art and is described, for example, in P. Buttel, R. Schlink, “Wasserbestimmung durch Karl-Fischer-Titration”, Metrohm Monograph 8.026.5001, 2003-06.

Although the applicant does not wish to make any exact scientific statement in this respect, the reaction kinetics in step a) depend on the reaction temperature, the effective surface area of the lithium fluoride, the water content, the flow resistance caused by the fixed bed or fluidized bed, and the flow rate, the pressure and the increase in volume of the reaction mixture during the reaction. While temperature, pressure and flow rate can be controlled by chemical engineering, the effective surface area of the lithium fluoride, the flow resistance and the increase in volume of the reaction mixture depend on the morphology of the lithium fluoride used.

It has been found that, both for use for producing shaped bodies and for use in the form of fine particles, it is advantageous to use lithium fluoride having an D50 of 4 to 1000 μm, preferably 15 to 1000 μm, more preferably 15 to 300 μm, especially preferably 15 to 200 μm and even more preferably 20 to 200 μm.

The lithium fluoride used further preferably has a D10 of 0.5 μm or more, preferably 5 μm or more, more preferably 7 μm or more. In another embodiment, the lithium fluoride has a D10 of 15 μm or more.

The D50 and the D10 mean, respectively, the particle size at which and below which a total of 10% by volume and 50% by volume of the lithium fluoride is present.

The lithium fluoride additionally preferably has a bulk density of 0.6 g/cm³ or more, preferably 0.8 g/cm³ or more, more preferably 0.9 g/cm³ or more and especially preferably of 0.9 g/cm³ to 1.2 g/cm³.

The lithium fluoride having the aforementioned specifications can be obtained, for example, by a process comprising at least the following steps:
i) providing an aqueous medium comprising dissolved lithium carbonate
ii) reacting the aqueous medium provided in a) with gaseous hydrogen fluoride to give an aqueous suspension of solid lithium fluoride
iii) separating the solid lithium fluoride from the aqueous suspension
iv) drying the separated lithium fluoride to the above-specified water content.

In step i), an aqueous solution comprising lithium carbonate is provided.

The term “aqueous medium comprising dissolved lithium carbonate” here is understood to mean a liquid medium which
i) contains dissolved lithium carbonate, preferably in an amount of at least 2.0 g/l, especially preferably 5.0 g/l up to the maximum solubility in the aqueous medium at the selected temperature, very especially preferably 7.0 g/l up to the maximum solubility in the aqueous medium at the selected temperature. More particularly, the lithium carbonate content is 7.2 to 15.4 g/l. The person skilled in the art is aware that the solubility of lithium carbonate is 15.4 g/l in pure water at 0° C., 13.3 g/l at 20° C., 10.1 g/l at 60° C. and 7.2 g/l at 100° C., and consequently certain concentrations can be obtained only at particular temperatures
ii) contains a proportion by weight of at least 50% water, preferably 80% by weight, especially preferably at least 90% by weight, based on the total weight of the liquid medium, and
iii) is preferably also solids-free or has a solids content of more than 0.0 up to 0.5% by weight, is preferably solids-free or has a solids content of more than 0.0 up to 0.1% by weight, is especially preferably solids-free or has a solids content of more than 0.0 up to 0.005% by weight, and is especially preferably solids-free,
   where the sum total of components i), ii) and preferably iii) is not more than 100% by weight, preferably 98 to 100% by weight and especially preferably 99 to 100% by weight, based on the total weight of the aqueous medium comprising dissolved lithium carbonate.

The aqueous medium comprising dissolved lithium carbonate may comprise, in a further embodiment of the invention, as a further component,
iv) at least one water-miscible organic solvent. Suitable water-miscible organic solvents are, for example, mono- or polyhydric alcohols such as methanol, ethanol, n-propanol, isopropanol, n-butanol, ethylene glycol, ethylene glycol monomethyl ether, ethylene glycol monoethyl ether, propylene glycol, propane-1,3-diol or glycerol, ketones such as acetone or ethyl methyl ketone.

If the aqueous medium comprising dissolved lithium carbonate comprises at least one water-miscible organic solvent, the proportion thereof may, for example, be more than 0.0% by weight to 20% by weight, preferably 2 to 10% by weight, where the sum total in each case of components i), ii), iii) and iv) is not more than 100% by weight, preferably 95 to 100% by weight and especially preferably 98 to 100% by weight, based on the total weight of the aqueous medium comprising dissolved lithium carbonate.

Preferably, however, the aqueous medium comprising dissolved lithium carbonate is free of water-miscible organic solvents.

The aqueous medium comprising dissolved lithium carbonate may contain, as a further component,
v) a complexing agent, preferably in an amount of 0.001 to 1% by weight, preferably 0.005 to 0.2% by weight, based on the total weight of the aqueous medium comprising dissolved lithium carbonate.

Complexing agents are preferably those whose complexes with calcium ions and magnesium ions have a solubility of more than 0.02 mol/l at a pH of 8 and 20′C. Examples of suitable complexing agents are ethylenediaminetetraacetic acid (EDTA) and the alkali metal or ammonium salts thereof, preference being given to ethylenediaminetetraacetic acid.

In one embodiment, however, the aqueous medium comprising dissolved lithium carbonate is free of complexing agents.

The procedure for provision of the aqueous solution comprising lithium carbonate is preferably to contact solid lithium carbonate with an aqueous medium which is free of lithium carbonate or low in lithium carbonate, such that the solid lithium carbonate at least partly goes into solution. An aqueous medium low in lithium carbonate is understood to mean an aqueous medium which has a lithium carbonate content of up to 1.0 g/l, preferably up to 0.5 g/l, but is not free of lithium carbonate.

The aqueous medium used for the provision fulfils the conditions mentioned above under ii) and iii), and optionally includes components iv) and v).

In the simplest case, the aqueous medium is water, preferably water having a specific electrical resistivity of 5 MΩ·cm at 25° C. or more.

In a preferred embodiment, steps i) to iv) are repeated once or more than once. In this case, in the repetition for provision of the aqueous medium comprising dissolved lithium carbonate, the aqueous medium free of lithium carbonate or low in lithium carbonate used is the aqueous medium which is obtained in a preceding step iii) in the separation of solid lithium fluoride from the aqueous suspension of lithium fluoride. In this case, the aqueous medium free of lithium carbonate or low in lithium carbonate comprises dissolved lithium fluoride, typically up to the saturation limit at the particular temperature.

In one embodiment, the aqueous medium free of or low in lithium carbonate can be contacted with the solid lithium carbonate in a stirred reactor, a flow reactor or any other apparatus known to those skilled in the art for the contacting of liquid substances with solid substances. Preferably, for the purpose of a short residence time and the attainment of a lithium carbonate concentration very close to the saturation point in the aqueous medium used, an excess of lithium carbonate is used, i.e. a sufficient amount that full dissolution of the solid lithium carbonate is not possible. In order to limit the solids content in accordance with ii) in this case, there follows a filtration, sedimentation, centrifugation or any other process which is known to those skilled in the art for separation of solids out of or from liquid, preference being given to filtration.

If process steps i) to iii) are performed repeatedly and/or continuously, filtration through a crossflow filter is preferred.

The contacting temperature may be, for example, from the freezing point to the boiling point of the aqueous medium used, preferably 0 to 100° C., especially preferably 10 to 60° C. and especially preferably 10 to 35° C., especially 16 to 24° C.

The contacting pressure may, for example, be 100 hPa to 2 MPa, preferably 900 hPa to 1200 hPa; especially ambient pressure is particularly preferred.

In the context of the invention, technical grade lithium carbonate is understood to mean lithium carbonate having a purity level of 95.0 to 99.9% by weight, preferably 98.0 to 99.8% by weight and especially preferably 98.5 to 99.8% by weight, based on anhydrous product.

Preferably, the technical grade lithium carbonate further comprises extraneous ions, i.e. ions that are not lithium or carbonate ions, in
1) a content of 200 to 5000 ppm, preferably 300 to 2000 ppm and especially preferably 500 to 1200 ppm of sodium in ionic form and/or
2) a content of 5 to 1000 ppm, preferably 10 to 600 ppm, of potassium in ionic form and/or
3) a content of 50 to 1000 ppm, preferably 100 to 500 ppm and especially preferably 100 to 400 ppm of calcium in ionic form and/or
4) a content of 20 to 500 ppm, preferably 20 to 200 ppm and especially preferably 50 to 100 ppm of magnesium in ionic form.

In addition, the technical grade lithium carbonate further comprises extraneous ions, i.e. ions that are not lithium or carbonate ions, in

i) a content of 50 to 1000 ppm, preferably 100 to 800 ppm, of sulphate and/or
ii) a content of 10 to 1000 ppm, preferably 100 to 500 ppm, of chloride, likewise based on the anhydrous product.

It is generally the case that the sum total of lithium carbonate and the aforementioned extraneous ions 1) to 4) and any i) and ii) does not exceed 1 000 000 ppm, based on the total weight of the technical grade lithium carbonate based on the anhydrous product.

In a further embodiment, the technical grade lithium carbonate has a purity of 98.5 to 99.5% by weight and a content of 500 to 2000 ppm of extraneous metal ions, i.e. sodium, potassium, magnesium and calcium.

In a further embodiment, the technical grade lithium carbonate preferably additionally has a content of 100 to 800 ppm of extraneous anions, i.e. sulphate or chloride, based on the anhydrous product.

The ppm figures given here, unless explicitly stated otherwise, are generally based on parts by weight; the contents of the cations and anions mentioned are determined by ion chromatography, unless stated otherwise according to the details in the experimental section.

In one embodiment of the process according to the invention, the provision of the aqueous medium comprising lithium carbonate and the contacting of an aqueous medium free of or low in lithium carbonate are effected batchwise or continuously with solid lithium carbonate, preference being given to continuous performance.

The aqueous medium comprising dissolved lithium carbonate provided in step i) typically has a pH of 8.5 to 12.0, preferably of 9.0 to 11.5, measured or calculated at 20° C. and 1013 hPa.

Before the aqueous medium comprising dissolved lithium carbonate provided in step i) is used in step iib), it can be passed through an ion exchanger, in order to at least partly remove calcium and magnesium ions in particular. For this purpose, it is possible to use, for example, weakly or else strongly acidic cation exchangers. For use in the process according to the invention, the ion exchangers can be used in devices such as flow columns, for example, filled with the above-described cation exchangers, for example in the form of powders, beads or granules.

Particularly suitable ion exchangers are those comprising copolymers of at least styrene and divinylbenzene, which additionally contain, for example, aminoalkylenephosphonic acid groups or iminodiacetic acid groups.

Ion exchangers of this kind are, for example, those of the Lewatit™ type, for example Lewatit™ OC 1060 (AMP type), Lewatit™ TP 208 (IDA type), Lewatit™ E 304/88, Lewatit™ S 108, Lewatit TP 207, Lewatit™ S 100; those of the Amberlite™ type, for example Amberlite™ IR 120, Amberlite™ IRA 743; those of the Dowex™ type, for example Dowex™ HCR; those of the Duolite type, for example Duolite™ C 20, Duolite™ C 467, Duolite™ FS 346; and those of the Imac™ type, for example Imac™ TMR, preference being given to Lewatit™ types.

Preference is given to using ion exchangers having minimum sodium levels. For this purpose, it is advantageous to rinse the ion exchanger prior to use thereof with the solution of a lithium salt, preferably an aqueous solution of lithium carbonate.

In one embodiment of the process according to the invention, no treatment with ion exchangers takes place.

In step ii), the aqueous medium comprising dissolved lithium carbonate provided in step i) is reacted with gaseous hydrogen fluoride to give an aqueous suspension of solid lithium fluoride.

The reaction can be effected, for example, by introducing or passing a gas stream comprising gaseous hydrogen fluoride into or over the aqueous medium comprising dissolved lithium carbonate, or by spraying or nebulizing the aqueous medium comprising dissolved lithium carbonate, or causing it to flow, into or through a gas comprising gaseous hydrogen fluoride.

Because of the very high solubility of gaseous hydrogen fluoride in aqueous media, preference is given to passing it over, spraying it, nebulizing it or passing it through, even further preference being given to passing it over.

The gas stream comprising gaseous hydrogen fluoride or gas comprising gaseous hydrogen fluoride used may either be gaseous hydrogen fluoride as such or a gas comprising gaseous hydrogen fluoride and an inert gas, an inert gas being understood to mean a gas which does not react with lithium fluoride under the customary reaction conditions. Examples are air, nitrogen, argon and other noble gases or carbon dioxide, preference being given to air and even more so to nitrogen.

The proportion of inert gas may vary as desired and is, for example, 0.01 to 99% by volume, preferably 1 to 20% by volume.

In a preferred embodiment, the gaseous hydrogen fluoride used contains 50 ppm of arsenic in the form of arsenic compounds or less, preferably 10 ppm or less. The stated arsenic contents are determined photometrically after conversion to hydrogen arsenide and the reaction thereof with silver diethyldithiocarbamate to give a red colour complex (spectrophotometer, e.g. LKB Biochrom, Ultrospec) at 530 nm.

In a likewise preferred embodiment, the gaseous hydrogen fluoride used contains 100 ppm of hexafluorosilicic acid or less, preferably 50 ppm or less. The hexafluorosilicic acid content reported is determined photometrically as silicomolybdic acid and the reduction thereof with ascorbic acid to give a blue colour complex (spectrophotometer, e.g. LKB Biochrom, Ultrospec). Disruptive influences by fluorides are suppressed by boric acid, and disruptive reactions of phosphate and arsenic by addition of tartaric acid.

The reaction in step ii) forms lithium fluoride, which precipitates out because of the fact that it is more sparingly soluble in the aqueous medium than lithium carbonate, and consequently forms an aqueous suspension of solid lithium fluoride. The person skilled in the art is aware that lithium fluoride has a solubility of about 2.7 g/l at 20° C.

The reaction is preferably effected in such a way that the resulting aqueous suspension of solid lithium fluoride attains a pH of 3.5 to 8.0, preferably 4.0 to 7.5 and especially preferably 5.0 to 7.2. Carbon dioxide is released at these pH values. In order to enable the release thereof from the suspension, it is advantageous, for example, to stir the suspension or to pass it through static mixing elements.

The reaction temperature in step ii) may, for example, be from the freezing point to the boiling point of the aqueous medium comprising dissolved lithium carbonate used, preferably 0 to 65° C., especially preferably 15 to 45° C. and especially preferably 15 to 35° C., especially 16 to 24° C.

The reaction pressure in step ii) may, for example, be 100 hPa to 2 MPa, preferably 900 hPa to 1200 hPa; especially ambient pressure is particularly preferred.

In step iii), the solid lithium fluoride is separated from the aqueous suspension.

The separation is effected, for example, by filtration, sedimentation, centrifugation or any other process which is known to those skilled in the art for separation of solids out of or from liquids, preference being given to filtration.

If the filtrate is reused for step i) and process steps a) to c) are conducted repeatedly, a filtration through a crossflow filter is preferred.

The solid lithium fluoride thus obtained typically still has a residual moisture content of 1 to 40% by weight, preferably 5 to 30% by weight.

Before the lithium fluoride separated in step iii) is dried in step iv), it can be washed once or more than once with water or a medium comprising water and water-miscible organic solvents. Water is preferred. Water having an electrical resistivity of 15 MΩ·cm at 25° C. or more is particularly preferred. Water containing extraneous ions which adheres to the solid lithium fluoride from step iii) is very substantially removed as a result.

In step iv), the lithium fluoride is dried. The drying can be conducted in any apparatus known to those skilled in the art for drying, for example a belt dryer, thin-film dryer or conical dryer. The drying is preferably effected by heating the lithium fluoride, preferably to 100 to 800° C., especially preferably 200 to 500° C. Alternatively, drying by means of microwaves is possible. The drying can either be effected such that the desired water content is attained directly, or such that water is again added to the lithium fluoride up to the desired amount after more intensive drying. In this case, in order to achieve very homogeneous distribution of the water in the solid lithium fluoride, for example, intensive mixing by grinding or stirring is possible, or the water can alternatively also be introduced in the form of a moist gas stream.

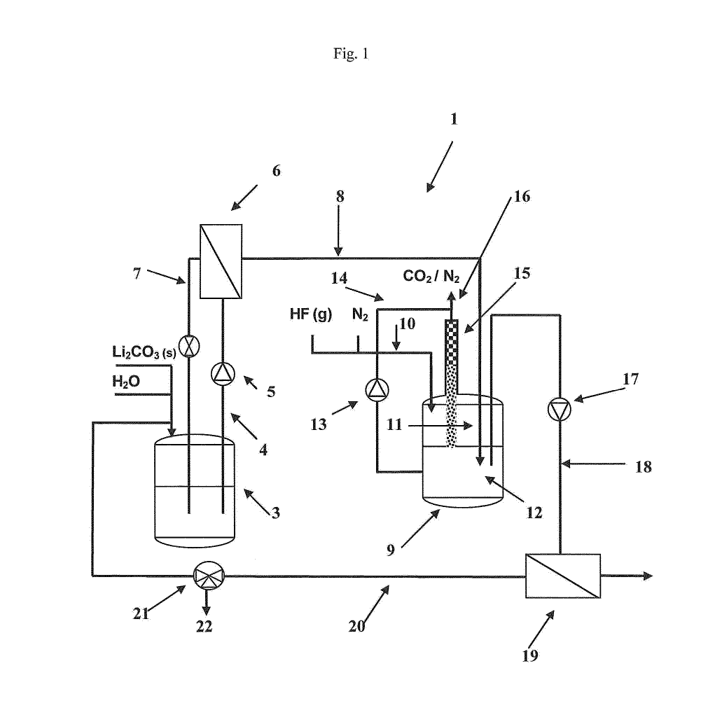

The preparation of lithium fluoride is illustrated in detail by FIG. 1.

In an apparatus for preparing lithium fluoride 1, solid lithium carbonate (Li₂CO₃(s)) is suspended with water (H₂O) and, if the apparatus 1 is not being filled for the first time, the filtrate from the filtration unit 19 in the reservoir 3, and the lithium carbonate goes at least partly into solution. The suspension thus obtained is conveyed via line 4 by the pump 5 through a filtration unit 6, which takes the form of a crossflow filter here, with undissolved lithium carbonate being recycled into the reservoir 3 via line 7, and the filtrate, the aqueous medium comprising dissolved lithium carbonate, is introduced via line 8 into the reactor 9. In the reactor 9, via line 10, a gas stream comprising gaseous hydrogen fluoride, which comprises gaseous hydrogen fluoride and nitrogen here, is introduced into the gas space 11 of the reactor, which is above the liquid space 12 of the reactor. The pump 13 conducts the contents of the liquid space 12, which at first consist essentially of the aqueous medium comprising dissolved lithium carbonate and are converted by the reaction to a suspension comprising solid lithium fluoride, via line 14 to a column 15 having random packing, in which the release of the carbon dioxide formed during the reaction from the suspension is promoted. The carbon dioxide and the nitrogen utilized as a diluent are discharged via the outlet 16. After passing through the columns having random packing, the contents of the liquid space 12 conducted out of the reactor 9 flow through the gas space 11 back into the liquid space 12. The recycling through the gas space 11 has the advantage that the liquid surface area is increased, partly by passive atomization as well, which promotes the reaction with gaseous hydrogen fluoride. After the target pH has been attained or sufficient solid lithium fluoride has formed, the suspension of solid lithium fluoride that has arisen is conveyed by means of the pump 17 via line 18 to the filtration unit 19, which takes the form here of a crossflow filter. The solid lithium fluoride (LiF(s)) is obtained; the filtrate, the aqueous medium free of lithium carbonate or low in lithium carbonate is recycled via line 20 into the reservoir 3. Since the lithium fluoride obtained has a residual content of water, and water is also discharged via the outlet 16 together with the carbon dioxide, the supply of water (H₂O) to the reservoir 3, after the first filling of the apparatus 1, serves essentially to compensate for the above-described water loss in further cycles.

It will be apparent to the person skilled in the art that extraneous metal ions such as, more particularly, sodium and potassium, which form carbonates and fluorides of good water solubility, will be enriched in the circulation stream of aqueous media. It is optionally possible to discharge a portion of the filtrate from the filtration unit 19 via the outlet 22 in the valve 21, which is configured here by way of example as a three-way valve.

The recycling of the filtrate from the filtration unit 19 into the reservoir 3 makes it possible, in the case of lithium fluoride preparation, to achieve a conversion level of 95% or more, especially even of 97% or more in the case of high numbers of repetitions of steps a) to d), also called cycle numbers, of, for example, 30 or more, “conversion level” being understood to mean the yield of high-purity lithium fluoride based on the lithium carbonate used.

In step a), solid lithium fluoride comprising the above-specified water content is contacted with a gas stream comprising phosphorus pentafluoride. The phosphorus pentafluoride can be prepared in a manner known per se by a process comprising at least the following steps:
1) reacting phosphorus trichloride with hydrogen fluoride to give phosphorus trifluoride and hydrogen chloride
2) reacting phosphorus trifluoride with elemental chlorine to give phosphorus dichloride trifluoride
3) reacting phosphorus dichloride trifluoride with hydrogen fluoride to give phosphorus pentafluoride and hydrogen chloride.

The gas mixture obtained in step 3) can be used directly as gas comprising phosphorus pentafluoride, either with or else without removing the hydrogen chloride in step a).

If particularly low chloride contents are to be achieved, hydrogen chloride is at least very substantially removed from the gas mixture, which can be accomplished by methods known per se, for example selective adsorption on basic adsorbents.

Alternatively, the chloride content can be lowered by introducing inert gas, for example nitrogen or argon, through the reactor after the reaction of PF₅ with LiF.

Alternatively, very substantially hydrogen chloride-free phosphorus pentafluoride can also be prepared by reacting tetraphosphorus decaoxide with hydrogen fluoride.

The gas comprising phosphorus pentafluoride used is typically a gas mixture containing 5 to 41% by weight of phosphorus pentafluoride and 6 to 59% by weight of hydrogen chloride, preferably 20 to 41% by weight of phosphorus pentafluoride and 40 to 59% by weight of hydrogen chloride, especially preferably 33 to 41% by weight of phosphorus pentafluoride and 49 to 59% by weight of hydrogen chloride, where the proportion of phosphorus pentafluoride and hydrogen chloride is, for example, 11 to 100% by weight, preferably 90 to 100% by weight and especially preferably 95 to 100% by weight.

The difference from 100% by weight, if any, may be inert gases, an inert gas being understood here to mean a gas which does not react with phosphorus pentafluoride, hydrogen fluoride, hydrogen chloride or lithium fluoride under the customary reaction conditions. Examples are nitrogen, argon and other noble gases or carbon dioxide, preference being given to nitrogen.

The difference from 100% by weight, if any, may alternatively or additionally also be hydrogen fluoride.

Based on the overall process over stages 1) to 3), hydrogen fluoride is used, for example, in an amount of 4.5 to 8, preferably 4.8 to 7.5 and especially preferably 4.8 to 6.0 mol of hydrogen fluoride per mole of phosphorus trichloride.

Typically, the gas comprising phosphorus pentafluoride is therefore a gas mixture containing 5 to 41% by weight of phosphorus pentafluoride, 6 to 59% by weight of hydrogen chloride and 0 to 50% by weight of hydrogen fluoride, preferably 20 to 41% by weight of phosphorus pentafluoride, 40 to 59% by weight of hydrogen chloride and 0 to 40% by weight of hydrogen fluoride, especially preferably 33 to 41% by weight of phosphorus pentafluoride, 49 to 59% by weight of hydrogen chloride and 0 to 18% by weight of hydrogen fluoride, where the proportion of phosphorus pentafluoride, hydrogen chloride and hydrogen fluoride is, for example, 11 to 100% by weight, preferably 90 to 100% by weight and especially preferably 95 to 100% by weight.

The reaction pressure in step a) is, for example, 500 hPa to 5 MPa, preferably 900 hPa to 1 MPa and especially preferably 0.1 MPa to 0.5 MPa.

The reaction temperature in step a) is, for example, −60° C. to 150° C., preferably between 20° C. and 150° C. and very especially preferably between −10° C. and 20° C. or between 50° C. and 120° C. At temperatures exceeding 120° C., it is preferable to work under pressure of at least 1500 hPa.

The reaction time in step a) is, for example, 10 s to 24 h, preferably 5 min to 10 h.

When a gas comprising phosphorus pentafluoride and hydrogen chloride is used, the gas leaving the fixed bed reactor or the fluidized bed is collected in an aqueous solution of alkali metal hydroxide, preferably an aqueous solution of potassium hydroxide, especially preferably in a 5 to 30% by weight, very especially preferably in a 10 to 20% by weight, particularly preferably in a 15% by weight, potassium hydroxide in water. Surprisingly, hydrogen chloride does not react to a measurable degree with lithium fluoride under the typical conditions of the invention, such that hydrogen chloride leaves the fixed bed reactor or fluidized bed reactor again and is then preferably neutralized.

Preferably, the gas or gas mixture used in step a) is prepared in the gas phase. The reactors, preferably tubular reactors, especially stainless steel tubes, used for that purpose, and also the fixed bed reactors or fluidized bed reactors to be used for the synthesis of lithium difluorophosphate, are known to those skilled in the art and are described, for example, in Lehrbuch der Technischen Chemie—Band 1, Chemische Reaktionstechnik [Handbook of Industrial Chemistry—Volume 1, Chemical Engineering], M. Baerns, H. Hofmann, A. Renken, Georg Thieme Verlag Stuttgart (1987), p. 249-256.

If solutions comprising lithium difluorophosphate are to be prepared, in step b), the reaction mixture comprising lithium difluorophosphate formed in a) is preferably contacted with an organic solvent.

The reaction mixture typically comprises the lithium difluorophosphate product of value and unconverted lithium fluoride.

Preferably, the reaction is conducted in such a way that 1 to 98% by weight, preferably 2 to 80% by weight and especially preferably 4 to 80% by weight of the solid lithium fluoride used is converted to lithium difluorophosphate.

In a preferred embodiment, the reaction mixture formed in a) is contacted with an organic solvent after the fixed bed or the fluidized bed has been purged with inert gas, and hence traces of hydrogen fluoride, hydrogen chloride or phosphorus pentafluoride have been removed. Inert gases are understood here to mean gases which do not react with phosphorus pentafluoride, hydrogen fluoride, hydrogen chloride or lithium fluoride under the customary reaction conditions. Examples are nitrogen, argon and other noble gases or carbon dioxide, preference being given to nitrogen.

Organic solvents used are preferably organic solvents which are liquid at room temperature and have a boiling point of 300° C. or less at 1013 hPa, and which additionally contain at least one oxygen atom and/or one nitrogen atom.

Preferred solvents are also those which do not have any protons having a pKa at 25° C., based on water or an aqueous comparative system, of less than 20. Solvents of this kind are also referred to in the literature as “aprotic” solvents.

Examples of such solvents are room-temperature-liquid nitriles, esters, ketones, ethers, acid amides or sulphones.

Examples of nitriles are acetonitrile, propanitrile and benzonitrile.

Examples of ethers are diethyl ether, diisopropyl ether, methyl tert-butyl ether, ethylene glycol dimethyl and diethyl ether, propane-1,3-diol dimethyl and diethyl ether, dioxane and tetrahydrofuran.

Examples of esters are methyl, ethyl and butyl acetate, or organic carbonates such as dimethyl carbonate (DMC), diethyl carbonate (DEC) or propylene carbonate (PC) or ethylene carbonate (EC).

One example of sulphones is sulpholane.

Examples of ketones are acetone, methyl ethyl ketone and acetophenone.

Examples of acid amides are N,N-dimethylformamide, N,N-dimethylacetamide, N-methylformanilide, N-methylpyrrolidone or hexamethylphosphoramide.

Particular preference is given to using acetonitrile, dimethyl carbonate (DMC), diethyl carbonate (DEC), propylene carbonate (PC) or ethylene carbonate (EC), or a mixture of two or more of these solvents. Especially preferably, dimethyl carbonate is used.

Preferably, when a fixed bed reactor or fluidized bed reactor is used, the contacting of the reaction mixture formed with an organic solvent for dissolution of the lithium difluorophosphate formed is effected for a period of 5 minutes to 24 hours, especially preferably of 1 hour to 5 hours, in such a way that the reactor contents of the fixed bed reactor or fluidized bed reactor are contacted with an organic solvent, preferably while stirring or pumping in circulation, until the lithium difluorophosphate content in the solvent remains constant.

For example, the weight ratio of organic solvent used to lithium fluoride originally used is 1:5 to 100:1.

In a further embodiment, a sufficient amount of organic solvent is used that the concentration of lithium difluorophosphate in the organic solvent that results after step b) or c) is from 0.1 up to the solubility limit in the solvent used at the dissolution temperature, for example 0.1 to 37% by weight, preferably from 0.3 to 10% by weight and especially preferably from 2 to 10% by weight. The person skilled in the art is aware, for example from WO2012/004188, of the different solubilities of lithium difluorophosphate in organic solvents.

The organic solvent to be used, before utilization thereof, is preferably subjected to a drying operation, especially preferably to a drying operation over a molecular sieve.

The water content of the organic solvent should be at a minimum. In one embodiment, it is 0 to 500 ppm, preferably 0 to 200 ppm and especially preferably 0 to 100 ppm.

Molecular sieves to be used with preference for drying in accordance with the invention are zeolites.

Zeolites are crystalline aluminosilicates which occur naturally in numerous polymorphs, but can also be produced synthetically. More than 150 different zeolites have been synthesized; 48 naturally occurring zeolites are known. For mineralogical purposes, the natural zeolites are embraced by the term “zeolite group”.

The composition of the substance group of zeolites is:

M^{B+}_{x/n}[AlO₂)ₓ.(SiO₂)_{y}]zH₂O
The factor n is the charge of the cation M and is preferably 1 or 2.
M is preferably a cation of an alkali metal or alkaline earth metal. These cations are required to balance the electrical charge of the negatively charged aluminium tetrahedra and are not incorporated into the main lattice of the crystal but reside in lattice cavities, and are therefore also readily mobile within the lattice and can also be exchanged subsequently.
The factor z indicates how many water molecules have been absorbed by the crystal. Zeolites can absorb water and other low molecular weight substances and release them again when heated, without destruction of their crystal structure.
The molar ratio of SiO₂ to AlO₂, i.e. x/y, in the empirical formula is referred to as the modulus. It cannot be smaller than 1 because of the Löwenstein rule.

Synthetic zeolites for use with preference as molecular sieve in accordance with the invention are:

| Zeolite | Composition of the unit cell |
|---|---|
| Zeolite A | Na₁₂[(AlO₂)₁₂(SiO₂)₁₂]•27H₂O |
| Zeolite X | Na₈₆[(AlO₂)₈₆(SiO₂)₁₀₆]•264H₂O |
| Zeolite Y | Na₃₆[(AlO₂)₈₆(SiO₂)₁₃₆]•250H₂O |
| Zeolite L | K₉[(AlO₂)₉(SiO₂)₂₇]•22H₂O |
| Mordenite | Na_{8.7}[(AlO₂)₈₆SiO₂)_{39.3}]•24H₂O |
| ZSM 5 | Na_{0.3}H_{3.8}[(AlO₂)_{4.1}(SiO₂)_{91.9}] |
| ZSM 11 | Na_{0.1}H_{1.7}[(AlO₂)_{1.8}(SiO₂)_{94.2}] |

The lithium difluorophosphate-containing organic solvent generally also comprises fractions of unconverted lithium fluoride, which is insoluble or not noticeably soluble, and which has been separated from the organic solvent in step c).

Preferably, the separation in step c) is effected by means of filtration, sedimentation, centrifugation or flotation, more preferably by means of filtration, especially preferably by means of filtration through a filter having a mean pore size of 200 nm or less. Further means of separating the solids are known to those skilled in the art.

The lithium fluoride separated is preferably recycled for use in step a). In this way, it is ultimately possible to convert a total of 60% by weight or more, preferably 70% by weight or more, of the lithium fluoride used to lithium difluorophosphate.

The apparatus used in the course of the present studies is described in FIG. 2. In FIG. 2, the symbols mean the following:
1 Reservoir for anhydrous hydrogen fluoride at controlled temperature, with mass flow controller
2 Reservoir for phosphorus trichloride
3 Reservoir for elemental chlorine
4 Pump
5 Phosphorus trichloride evaporator
6 Stainless steel tube
7 Stainless steel tube
8 Heat exchanger
9 Fluidized bed reactor
10 Stirrer
11 Scrubber
12 Disposal vessel

Preference is given to using a combination of initially at least two series-connected tubular reactors, preferably stainless steel tube 6 and stainless steel tube 7, for preparation of phosphorus pentafluoride in combination via at least one heat exchanger with at least one fixed bed reactor or fluidized bed reactor, in which the reaction of the phosphorus pentafluoride and finally of water-containing solid lithium fluoride to give lithium difluorophosphate is effected.

The reaction flow of the reactants is described by way of example with reference to FIG. 2, here with two tubular reactors, one heat exchanger and one fluidized bed reactor, as follows. Preheated hydrogen fluoride, preferably preheated to 30° C. to 100° C., is metered in gaseous form from a reservoir 1 through a heated stainless steel tube 6, preferably at temperatures of 20° C. to 600° C., especially preferably 300° C. to 500° C., and reacted with gaseous phosphorus trichloride. The gaseous phosphorus trichloride is transferred beforehand in liquid form from reservoir 2 by means of pump 4 into the evaporator 5, preferably in heated form at between 100° C. and 400° C., especially preferably between 200° C. and 300° C., transferred therefrom and mixed with the hydrogen fluoride in the stainless steel tube 6, the latter having been heated, preferably to the abovementioned temperatures. The reaction mixture obtained is transferred into stainless steel tube 7 and mixed therein with elemental chlorine from reservoir 3, preferably heated to 20° C. to 400° C., especially preferably to 200° C. to 300° C., and reacted. The resulting gas mixture comprising phosphorus pentafluoride is cooled by means of heat exchangers, preferably to −60° C. to 80° C., especially preferably to −10° C. to 20° C., and contacted with solid lithium fluoride in the fluidized bed reactor 9, preferably at temperatures of −60° C. to 150° C., preferably between 20° C. and 150° C. and very especially preferably between −10° C. and 20° C. or between 50° C. and 120° C., preferably by stirring by means of stirrer 10 or by fluidization or a combination of the two. The gas mixture leaving the fluidized bed reactor 9 is freed of acidic gases in the scrubber 11, and the halide-containing solution obtained is transferred into the disposal vessel 12. The solid reaction mixture remains in the fixed bed reactor/fluidized bed reactor 9 and is partly dissolved therein by contacting with the organic solvent, and the suspension obtained is separated from the solids.

In the reaction, according to the water content of the lithium fluoride used, it is additionally also possible for different amounts of lithium hexafluorophosphate to form in controllable amounts. In this respect, the process according to the invention is also suitable for controlled production of solutions of lithium difluorophosphate and lithium hexafluorophosphate in organic solvents. If a separation of lithium hexafluorophosphate from the lithium difluorophosphate is desired, it is possible to exploit the typically very different solubility in organic solvents, and to use, in a subsequent step c2), for example, a solvent in which lithium difluorophosphate is more sparingly soluble than in the solvent that was used in step b), in order thus to precipitate lithium difluorophosphate. For example, it is possible to use, in step b), acetonitrile, ketones, for example acetone, and ethers, for example dimethoxyethane, and to effect the precipitation, for example, with diethyl carbonate, dimethyl carbonate or ethylene carbonate or propylene carbonate. This leaves lithium hexafluorophosphate in solution. The amounts required for the precipitation can be determined by the person skilled in the art in a simple preliminary experiment. In this way, lithium difluorophosphate can be obtained with a proportion of extraneous metal ions so low as to be unobtainable by the processes in the prior art.

The invention therefore also encompasses lithium difluorophosphate having a purity level of 99.9000 to 99.9995% by weight, preferably 99.9500 to 99.9995% by weight and especially preferably 99.9700 to 99.9995% by weight, based on anhydrous product.

The lithium difluorophosphate additionally preferably contains extraneous ions in
1) a content of 0.1 to 75 ppm, preferably 0.1 to 50 ppm and especially preferably 0.5 to 10 ppm and especially preferably 0.5 to 5 ppm of sodium in ionic form and
2) a content of 0.01 to 10 ppm, preferably 0.5 to 5 ppm and especially preferably 0.1 to 1 ppm of potassium in ionic form.

The lithium fluoride additionally preferably contains extraneous ions in
3) a content of 0.05 to 300 ppm, preferably 0.1 to 250 ppm and especially preferably 0.5 to 100 ppm of calcium in ionic form and/or
4) a content of 0.05 to 300 ppm, preferably 0.1 to 250 ppm and especially preferably 0.5 to 50 ppm of magnesium in ionic form.

In one embodiment, the lithium difluorophosphate contains a content of extraneous metal ions totaling 300 ppm or less, preferably 20 ppm or less and especially preferably 10 ppm or less.

If the solution comprising lithium difluorophosphate is not used directly as electrolyte or for production of an electrolyte, the following may be effected as step

d): the at least partial removal of organic solvent.

If the removal is partial, the establishment of a specific content of lithium difluorophosphate is possible. If the removal is very substantially complete, it is likewise possible to obtain high-purity lithium difluorophosphate in solid form. “Very substantially complete” means here that the remaining content of organic solvent is 5000 ppm or less, preferably 2000 ppm or less.

The invention therefore further relates to the use of the solutions obtained in accordance with the invention as or for production of electrolytes for lithium accumulators, or for preparation of solid lithium difluorophosphate.

The invention further relates to a process for producing electrolytes comprising lithium difluorophosphate for lithium accumulators, characterized in that it comprises at least steps a) to c) and optionally d).

The particular advantage of the invention lies in the efficient procedure and the high purity of the lithium difluorophosphate obtained.

### EXAMPLES

The unit “%” hereinafter should always be understood to mean % by weight.

In relation to the ion chromatography used in the course of the present studies, reference is made to the publication from the TU Bergakademie Freiberg, Faculty of Chemistry and Physics, Department of Analytical Chemistry, from March 2002, and the literature cited therein.

In the course of the present study, the concentration of LiPO₂F₂ was measured with an ion chromatograph with the following parameters:

Instrument type: Dionex ICS 2100
Column: IonPac® AS20 2*250-mm “Analytical Column with guard”
Sample volume: 1 μl
Eluent: KOH gradient: 0 min/15 mM, 10 min/15 mM, 13 min/80 mM, 27 min/100 mM, 27.1 min/15 mM, 34 min/15 mM
Eluent flow rate: 0.25 ml/min
Temperature: 30° C.
Self-regenerating suppressor: ASRS® 300 (2-mm)

The assignment of the signals obtained to the LiPO₂F₂ was confirmed by means of ³¹P and ¹⁹F NMR spectroscopy. Details of the separation of LiPO₂F₂ from other phosphorus/fluorine-containing compounds by ion chromatography can also be found in Lydia Terborg Sascha Nowak, Stefano Passerini, Martin Winter, Uwe Karst, Paul R. Haddad, Pavel N. Nesterenko, Analytica Chimica Acta 714 (2012) 121-126.

### Example 1

### Preparation of High-Purity Lithium Fluoride

In an apparatus according to FIG. 1, the reservoir 3 was initially charged with 500 g of solid lithium carbonate of technical grade quality (purity: >98% by weight; Na: 231 ppm, K: 98 ppm, Mg: 66 ppm, Ca: 239 ppm) and 20 l of water, and a suspension was prepared at 20° C. After about five minutes, the suspension was conducted through the filtration unit 6, which took the form of a crossflow filter, and the resultant medium comprising dissolved lithium carbonate, here an aqueous solution of lithium carbonate having a content of 1.32% by weight, was conducted into the reactor 9 via line 8.

After a total of 4 kg of the medium had been pumped into the reactor 9, the feed from the filtration unit 6 was stopped and, in the reactor 9, the feed of gaseous hydrogen fluoride into the gas space 11 was commenced, with continuous pumped circulation of the medium through the pump 13, the line 14 and the column 15 having random packing. This metered addition was ended when the pH of the solution pumped in circulation was 7.0.

The resultant suspension from the reactor 9 was conveyed by means of the pump 17 and via line 18 to the filtration unit 19, which was designed here as a pressurized suction filter and filtered therein, and the filtrate, a lithium carbonate-free aqueous medium here, was conveyed via line 20 back to the reservoir 3. The lithium carbonate-free aqueous medium had a lithium fluoride content of about 0.05% by weight.

The above-described operation was repeated five times.

The still water-moist lithium fluoride (148 g in total) separated in the filtration unit 19 was removed and washed three times in a further pressurized suction filter with water having a conductivity of 5 MΩ·cm at 25° C. (30 ml each time).

The lithium fluoride thus obtained was dried in a vacuum drying cabinet at 90° C. and 100 mbar.

Yield: 120 g of a fine white powder.

The product obtained had a potassium content of 0.5 ppm and a sodium content of 2.5 ppm; the magnesium content of the product was 99 ppm, the calcium content 256 ppm. The chloride content was less than 10 ppm.

The residual moisture content was 500 ppm of water.

The measurement of the particle size distribution gave a D50 of 45 μm and a D10 of 22 μm. The bulk density was 1.00 g/cm³.

Over the course of performance of 50 cycles (repetitions), a total of 97% of the lithium carbonate used was obtained in the form of high-purity lithium fluoride.

### Example 2a

### Preparation of High-Purity Lithium Difluorophosphate in Acetonitrile (Inventive)

A mixture of 0.6 g/min of PCl₃ and a little more than five times the equimolar amount of HF (both in gaseous form) were passed through a stainless steel tube (ID 8 mm) of length about 6 m which had been heated to 450° C. 8 l/h of chlorine were introduced into this reaction mixture and passed through a further stainless steel tube (ID 8 mm) of length about 4 m which had been heated to 250° C.

The reaction product was cooled to −20° C. and then passed through a fixed bed reactor having a diameter of about 45 mm which had been partly filled with lithium fluoride according to Example 1 (69.5 g). 500 μl of water were added to this powder with the aid of a syringe. The powder was stirred with a stirrer, also under reaction conditions. The total water content was determined to be 7140 ppm.

The gas mixture that left this lithium fluoride-filled reactor was collected in an aqueous 15% by weight KOH.

After a total reaction time of about 7 hours, the metered addition of the reagents was replaced by the metered addition of inert gas, and the reaction gas was displaced from the system. Subsequently, the reaction product was washed in three portions with a total of 1000 ml of acetonitrile dried over 3 A molecular sieve, and the wash solutions were analysed.

A total of 15.8 g of lithium difluorophosphate were obtained in the form of a solution in acetonitrile. By extending the reaction time, extending the contact time and increasing the reaction temperature, and also increasing the water content, it is possible to further enhance the yield and the ratio of lithium difluorophosphate to lithium hexafluorophosphate.

The solution also contained 21.52 g of lithium hexafluorophosphate.

### Example 3

### Attempted Preparation of Lithium Difluorophosphate in Acetonitrile (Noninventive)

The procedure was entirely analogous to Example 2, with the difference that no water was added to the lithium fluoride, meaning that the lithium fluoride had a water content of 500 ppm. In addition, the reaction time was extended to 13.5 hours.

Overall, as well as 80.5 g of lithium hexafluorophosphate, only 0.095 g of lithium difluorophosphate were obtained in the form of a solution in acetonitrile, in spite of the longer reaction time and the higher reaction gas temperature.

1. A process for preparing lithium difluorophosphate, the process comprising:
a) contacting solid lithium fluoride having a water content of more than 1500 ppm with a gas comprising phosphorus pentafluoride.

2. The process according to claim 1, wherein a reaction mixture of lithium difluorophosphate and lithium hexafluorophosphate is formed in step a) and the method further comprises:
b) contacting the reaction mixture formed in a) with an organic solvent, causing the lithium difluorophosphate formed to go at least partly into solution, and
c) optionally separating solid constituents comprising the lithium hexafluorophosphate from the solution.

3. The process according to claim 1 or 2, wherein the lithium fluoride has a purity level of 98.0000 to 99.9999% by weight, based on anhydrous product.

4. The process according to claim 1, wherein the lithium fluoride includes extraneous ions in
a content of 0.1 to 250 ppm of sodium in ionic form, and
a content of 0.01 to 200 ppm of potassium in ionic form.

5. The process according to claim 1, wherein the lithium fluoride includes extraneous ions in
a content of 0.05 to 500 ppm of calcium in ionic form, and/or
a content of 0.05 to 300 ppm of magnesium in ionic form.

6. The process according to claim 1, further comprising contacting the solid lithium fluoride with the gas in a fixed bed or a fluidized bed.

7. The process according to claim 1, further comprising obtaining the lithium fluoride by a process comprising:
providing an aqueous medium comprising dissolved lithium carbonate;
reacting the aqueous medium with gaseous hydrogen fluoride to give an aqueous suspension of solid lithium fluoride;
separating the solid lithium fluoride from the aqueous suspension; and
drying the separated lithium fluoride.

8. The process according to claim 1, further comprising preparing the phosphorus pentafluoride by at least one of:
A) reacting phosphorus trichloride with hydrogen fluoride to give phosphorus trifluoride and hydrogen chloride;
reacting the phosphorus trifluoride with elemental chlorine to give phosphorus dichloride trifluoride; and
reacting the phosphorus dichloride trifluoride with hydrogen fluoride to give phosphorus pentafluoride and hydrogen chloride; and
B) reacting tetraphosphorus decaoxide with hydrogen fluoride to give phosphorus pentafluoride.

9. The process according to claim 1, further comprising conducting the reaction in step a) at a pressure of 500 hPa to 5 MPa.

10. The process according to claim 2, wherein the organic solvents are solvents which are liquid at room temperature and have a boiling point of 300° C. or less at 1013 hPa, and which additionally contain at least one oxygen atom and/or one nitrogen atom.

11. The process according to claim 10, wherein the solvents are room-temperature-liquid nitriles, esters, ketones, ethers, acid amides or sulphones.

12. The process according to claim 2, further comprising obtaining solid lithium difluorophosphate in a subsequent step by one of:
d1) adding an organic solvent in which lithium difluorophosphate is more sparingly soluble than in the organic solvent that was used in step b), in order thus to precipitate the lithium difluorophosphate, or by, in one step, and
d2) removing the organic solvent.

13. Lithium difluorophosphate having a purity level of 99.9000 to 99.9995% by weight based on anhydrous product.

14. The lithium difluorophosphate according to claim 13, wherein the lithium difluorophosphate comprises extraneous metal ions in:
a content of 0.1 to 75 ppm of sodium in ionic form,
a content of 0.01 to 10 ppm of potassium in ionic form, and
at least one of
a content of 0.05 to 300 ppm of calcium in ionic form, and
a content of 0.05 to 300 ppm of magnesium in ionic form,
where the lithium difluorophosphate includes a content of extraneous metal ions totaling 300 ppm or less.

15. A process for producing electrolytes for lithium accumulators, the electrolytes comprising lithium difluorophosphate, and the process comprising:
a) contacting solid lithium fluoride having a water content of more than 1500 ppm with a gas comprising phosphorus pentafluoride to produce a reaction mixture of lithium difluorophosphate and lithium hexafluorophosphate;
b) contacting the reaction mixture with an organic solvent, causing the lithium difluorophosphate formed to go at least partly into solution, and
c) separating solid constituents comprising lithium hexafluorophosphate from the solution; and
optionally obtaining solid lithium difluorophosphate by one of:
d1) adding an organic solvent in which lithium difluorophosphate is more sparingly soluble than in the organic solvent that was used in step b), in order thus to precipitate the lithium difluorophosphate, or
d2) in one step, removing the organic solvent.

16. The lithium difluorophosphate according to claim 14, wherein:
the content of sodium in ionic form is 0.5 to 5 ppm,
the content of potassium in ionic form is 0.1 to 1 ppm,
and, if present
the content of calcium in ionic form is 0.5 to 100 ppm, and/or
the content of magnesium in ionic form is 0.5 to 50 ppm.

17. The lithium difluorophosphate according to claim 16, wherein the lithium difluorophosphate includes a content of extraneous metal ions of 10 ppm or less.

18. The process according to claim 1, wherein the solid lithium fluoride has:
a water content of 5000 ppm to 15,000 ppm; and
a purity level of 99.9700 to 99.9995% by weight, based on anhydrous product.

19. The process according to claim 18, wherein the lithium fluoride includes extraneous metal ions of sodium, potassium, and at least one of calcium and magnesium, in
a content of 0.1 to 50 ppm of sodium in ionic form,
a content of 0.01 to 10 ppm of potassium in ionic form, and
if present,
a content of 0.05 to 300 ppm, of calcium in ionic form, and/or
a content of 0.1 to 250 ppm of magnesium in ionic form.

20. The process according to claim 19, further comprising conducting the reaction in step a) at a pressure of 1500 hPa to 0.5 MPa.
